(19) United States
(12) Patent Application Publication
(10) Pub. No.: US 2008/0255268 A1
(43) Pub. Date: Oct. 16, 2008

(54) Friction material

(76) Inventor: Masaaki Kobayashi, Obu (JP)

Correspondence Address: BUCHANAN, INGERSOLL & ROONEY PC, POST OFFICE BOX 1404, ALEXANDRIA, VA, 22313-1404, US

(21) Appl. No.: 12/076,770

(22) Filed: Mar. 21, 2008

(30) Foreign Application Priority Data
Apr. 10, 2007 (JP) 2007-103134
Dec. 10, 2007 (JP) 2007-318117

(51) Int. Cl. C08J 5/14

(52) U.S. Cl. 523/152

(57) ABSTRACT

A friction material contains a friction adjuster, a binder and an inorganic filler. The friction material further contains randomly shaped rubber chips which contain machining dust derived from friction material, and rubber binding the machining dust. The rubber chips are preferably sized so as to pass through a 16-mesh sieve. Since the friction material contains machining dust of friction materials, it is possible to reduce wastes and the cost of the friction material. Still, the friction material shows sufficient basic properties comparable to conventional friction materials, including environmental friendliness, braking effect, and reduced squeal and other noise.

### CROSS REFERENCE TO RELATED APPLICATIONS

This application is based on and claims priority under 35 U.S.C. sctn. 119 with respect to Japanese Patent Application No. 2007-103134 filed on Apr. 10, 2007 and No. 2007-318117 filed on Dec. 10, 2007, the entire content of which is incorporated herein by reference.

### BACKGROUND OF THE INVENTION

This invention relates to a friction material such as a brake pad or a brake lining which is comparable in performance to conventional friction materials and which contains fine machining dust derived from friction materials when the friction materials are polished, ground, cut and/or pulverized, thereby making it possible to reduce wastes and the cost.

Friction materials used e.g. for vehicle brakes (such as brake pads of disc brakes and brake linings of drum brakes) are produced by subjecting a mixture powder of raw materials containing a binder such as phenolic resin to heat/pressure forming, and then to heat treatment to cure its binder, and by aging and finishing. In the finishing step, the friction surfaces are ground to predetermined dimensions. In the case of a brake pad, its edges are removed by chamfering and/or slits are formed in the friction surface to divide the friction surface into a plurality of sections to reduce noise and heat buildup. As a result of such machining of friction materials, large amounts of machining dust are produced daily. Currently, most of such dust is collected by waste disposal companies as industrial wastes and buried, recycled as a raw material for cement, or otherwise disposed of.

Because such machining dust is mostly disposed of as industrial wastes, such dust has not been effectively recycled or otherwise used. It is therefore desired to reuse such machining dust produced when producing friction materials as a raw material for new friction materials. Proposals have already been made to answer such requirements.

For example, JP Patent Publication 10-087848A (Publication 1) proposes a method of producing a friction material which comprises the steps of laminating a surface layer made of a material containing polishing dust on the friction material body, forming the friction material into a predetermined shape, and removing the surface layer by polishing. JP Patent Publication 2005-200569A (Publication 2) proposes a friction material containing composite particles (which correspond to “machining dust” herein used) obtained by pulverizing waste friction materials. It is taught in Publication 2 that the composite particles are preferably obtained by heat-treating friction materials at a high temperature and then pulverizing them.

Similar techniques are also disclosed in the following Patent publications:

### Publication 3: JP Patent Publication 05-078649A

### Publication 4: JP Patent 2991970

### Publication 5: JP Patent Publication 11-101284A

### Publication 6: JP Patent Publication 2005-233214

Machining dust of friction material comprises extremely fine particles (ordinary polishing dust has an average particle diameter of about 10 μm, so that it is difficult to handle such machining dust. In the method disclosed in Publication 1, machining dust may be scattered in the air, thus polluting the environment.

Also, because the friction material body that remains after polishing has a different composition from the surface layer to be removed by polishing, the mixture powder to be formed into the surface layer has to be put into a mold separately from the mixture powder to be formed into the friction material body. It is also necessary to control the content ratio of the above two different mixture powders. Thus, productivity is low.

In the case of the friction material disclosed in Publication 2, too, since the pulverized composite particles are directly added to the mixture powder, the composite particles may be scattered in the air, thus polluting the environment. Also, composite particles obtained by pulverizing heat-treated friction materials, which are considered preferable in Publication 2, has a porous structure because organic components are removed during heat treatment. A friction material containing such composite particles is therefore high in porosity and thus low in friction coefficient and inferior in fade properties.

The technologies disclosed in Publications 3 to 6 also have similar problems and are not completely satisfactory.

### SUMMARY OF THE INVENTION

An object of the present invention is to provide a friction material which contains machining dust of friction materials, thereby reducing wastes and the cost of the friction material, and which still shows sufficient basic properties comparable to conventional friction materials, including environmental friendliness, braking effect, and reduced squeal and other noise.

To achieve this object, the present invention provides a friction material comprising a fibrous base material, a friction adjuster, a binder, an inorganic filler, and randomly shaped rubber chips made from kneading rubber and machining dust of friction material.

Preferably, the rubber chips are sized so as to pass through a 16-mesh (about 1 mm) sieve. The weight ratio of the rubber in the rubber chips to the machining dust in the rubber chips is preferably 50/50 to 5/95, more preferably 10/90 to 25/75. Also, the total rubber content in the rubber chips is 3% by weight of the entire friction material.

Fine machining dust of friction materials is difficult to handle, and could pollute the environment. To solve this problem, according to the present invention, instead of directly handling such machining dust, such dust is kneaded with rubber, the kneaded mixture is formed into chips, and the chips are added to the material of the friction material.

The material comprising machining dust kneaded with and bound by rubber may be formed into chips by pelletizing. But by pelletizing, it is difficult to reduce the average particle diameter to less than about 1 mm. Thus, if chips formed by pelletizing are added to a friction material, the rubber chips tend to be distributed unevenly in the friction material. This impairs the friction coefficient, heat resistance (fade properties) and other properties.

In contrast, because the rubber chips used in the present invention are sized so as to pass through a 16-mesh sieve, the rubber chips are uniformly dispersed in the friction material, so that its friction coefficient stabilizes. The friction material according to the present invention therefore shows performance comparable to conventional friction materials containing no rubber chips.

Taking into consideration both uniformity in dispersion and handling of the rubber chips, the content of rubber chips having dimensions not less than 16 mesh (about 1 mm) is preferably limited to less than 1%. Such rubber chips are substantially equal in size to cashew dust which is ordinarily added to friction materials, so that such rubber chips can be handled in the same manner as cashew dust. If the size of the rubber chips is larger, the rubber chips tend to be distributed unevenly in the friction material when the friction material is produced. Thus, the content of rubber chips in the friction material tends to be uneven. This may cause cracks, chipping and peeling of the friction material at its portions where the content of rubber chips is high. For the brake performance too, due to reduced heat resistance, the fade properties of such a friction material may deteriorate.

### BRIEF DESCRIPTION OF THE DRAWINGS

Other features and objects of the present invention will become apparent from the following description made with reference to the accompanying drawings, in which:

FIG. 1 is a flowchart of the production steps of the friction material according to the present invention;

FIG. 2 is a graph showing the particle diameter distribution of the classified rubber chips in comparison with the particle diameter distribution of cashew dust;

FIGS. 3A and 3B show the size of rubber chips pulverized in a rubber mill and the size of rubber chips formed by pulverizing, respectively;

FIG. 4 is a graph showing the friction coefficient of a friction material containing rubber chips comprising machining dust of friction materials which is kneaded with rubber, in comparison with the friction coefficient of an original friction material containing no such rubber chips, as measured by the second effect under JASO C406-87; and

FIG. 5 is a graph showing the friction coefficient of a friction material containing rubber chips comprising machining dust of friction materials which is kneaded with rubber, in comparison with the friction coefficient of an original friction material containing no such rubber chips, when fading occurs.

### DETAILED DESCRIPTION OF THE PREFERRED EMBODIMENTS

Now the friction material embodying this invention is described. The friction material according to the invention includes a fibrous base material selected from organic and inorganic fibers such as aramid fibers, steel fibers, copper fibers and rock wool. The friction material further contains cashew dust, graphite, calcium hydroxide, etc. as friction adjusters and fillers, and also contains other inorganic fillers such as mica, zirconium oxide or barium sulfate. Needless to say, it also contains a binder such as a thermosetting resin, typically a phenolic resin. Besides these substances, the friction material according to this invention contains rubber chips which characterize the present invention and comprise cutting/machining dust produced from friction materials, and rubber binding the cutting/machining dust.

The rubber used in the rubber chips containing the cutting/machining dust (hereinafter simply referred to as “rubber chips”) may be any ordinarily industrially used rubber, such as nitrile rubber (NBR), hydrogenated nitrile rubber (HNBR), styrene rubber (SBR), ethylene-propylene-diene rubber (EPDM), butyl rubber, acrylic rubber and silicone rubber. The rubber may or may not contain vulcanizing agents. Among these rubbers, NBR is most desirable, and SBR and EPDM are the second most desirable, from the economic viewpoint. HNBR is expensive. While silicone rubber is highly heat-resistant, since it is expensive, it should be used only when higher performance is required for the rubber which any other inexpensive rubber such as NBR cannot accomplish.

The cutting/machining dust added to the rubber chips is preferably entirely produced from a single friction material so that the entire dust has a uniform composition. But if it is possible to control the composition of the dust, the dust may be produced from waste friction materials or friction materials having slightly different compositions from each other.

Preferably, the rubber chips have an average size of 250 to 500 μm. The weight ratio between the rubber and the cutting/machining dust in the rubber chips is preferably 50/50 to 5/95. The total rubber content in the rubber chips is preferably not more than 3% by weight of the entire friction material.

If the content of the rubber in the rubber chips is less than 5% by weight, the rubber content is too low for the rubber to sufficiently bind the dust, so that it is impossible to form the rubber-dust mixture into chips. If the rubber content is higher than 50% by weight, the amount of the cutting/machining dust is so small (provided the rubber chip content in the friction material is within the preferable range) that the recycling rate of the cutting/machining dust lowers. More preferably, the rubber-to-dust weight ratio is 10/90 to 25/75.

But as mentioned above, the total rubber content in the rubber chips is preferably limited to 3% by weight or less of the entire friction material. If this value is higher than 3% by weight, the strength and the heat resistance of the friction material tend to deteriorate to such a degree that the friction material according to the invention is inferior in various characteristics to conventional friction materials. But if the total rubber content in the friction material is too low, the recycling rate of waste friction materials decreases. Thus, the content of the rubber chips in the friction material is preferably controlled so that the total rubber content in the friction material is not less than 0.5% by weight. By mixing rubber and cutting/machining dust in the above-described preferable ratio to form the rubber chips, and adding the thus produced rubber chips by about 5 to 30% by volume, it is possible to satisfy all of the abovementioned requirements.

The rubber chips are produced by kneading cutting/machining dust and rubber as a binder in a predetermined ratio, and forming the mixture into chips. Cutting/machining dust and rubber may be kneaded in an ordinary rubber-kneading device, such as a pressure kneader, an open-roll mill, a Banbury mixer or an extruder. The thus kneaded mixture is formed into chips in a rubber mill, which is used to pulverize or shred rubber. A rubber mill comprises two opposed discs that rotate relative to each other and carry numerous blades on the opposed surfaces thereof which randomly shred and pulverize rubber material between the discs.

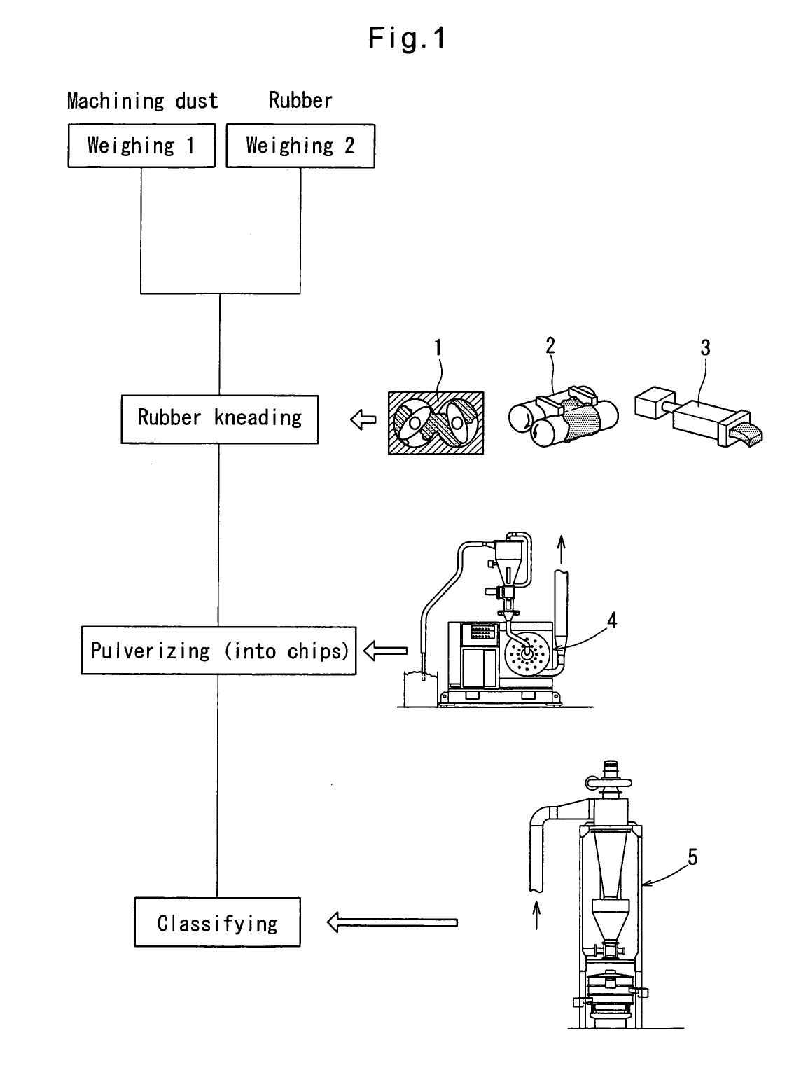

Such a rubber mill can easily produce not only rubber chips having an average size of not more than 1 mm, which are difficult to produce by pelletizing, but also rubber chips having an average size of 250 to 500 μm, the preferred range according to the present invention. FIG. 1 shows the steps for forming such rubber chips.

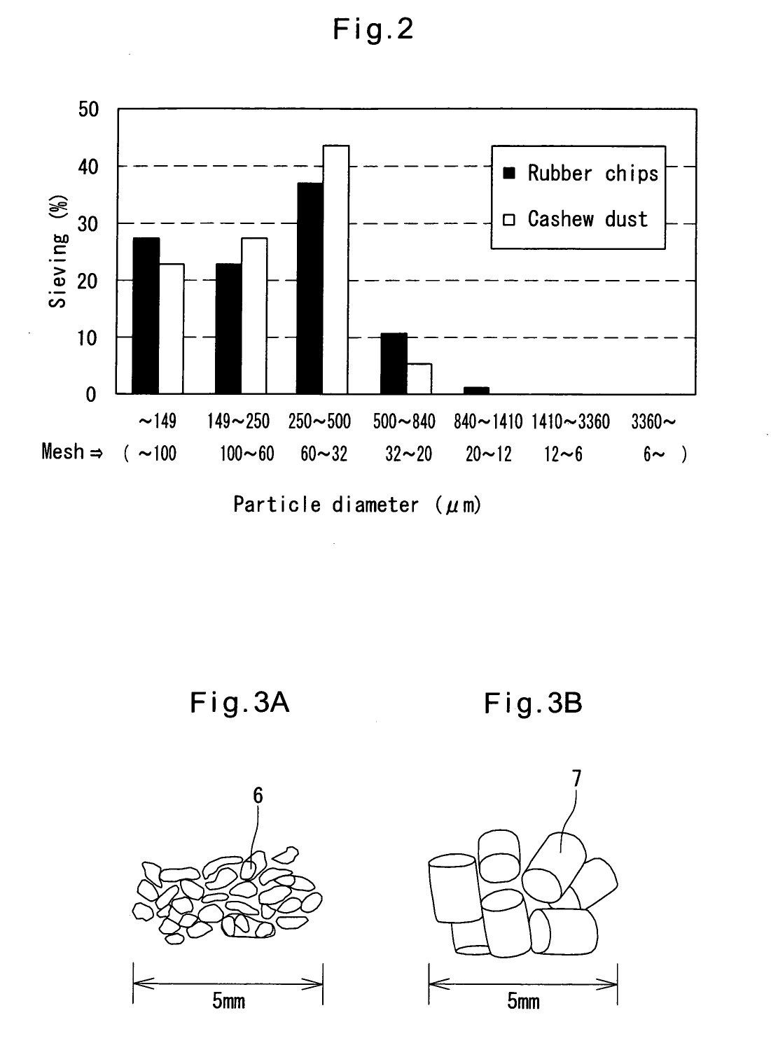

In the step of rubber kneading shown in FIG. 1, a pressure kneader 1, an open-roll mill 2 and an extruder 3 are used to knead grinding dust with rubber, after weighing them. The thus kneaded mixture is formed e.g. into a sheet, and the sheet is pulverized in a rubber mill 4 into randomly shaped rubber chips. The rubber chips are then classified in a classifier 5. (The classifier shown in FIG. 1 is an air classifier.) FIG. 2 shows the particle diameter distribution of the thus classified rubber chips in comparison with the particle diameter distribution of cashew dust. As will be apparent from FIG. 2, the rubber chips obtained by pulverizing with a rubber mill have particle diameters substantially equal to cashew dust, which is ordinarily added to friction materials as a filler, so that no special handling is necessary for such rubber chips.

The thus classified rubber chips are added by a predetermined amount to raw materials for the friction material (fibrous base material, friction adjusters, binders and inorganic fillers). These substances, including the rubber chips, are mixed together. The mixture powder thus obtained is preformed in a press on which forming dies are set. The thus preformed body is heated under pressure in a press on which forming dies are set to provide a formed body. The formed body is then heat-treated for curing the binder, aged, and finished. A desired friction material is thus formed.

The formed body to be formed into a friction material is ordinarily produced at a temperature of about 130 to 200° C. and at a forming pressure of about 10 to 100 MPa. The heat treatment of the formed body for curing the binder is carried out at a temperature of about 140 to 300° C. for about 2 to 48 hours. The friction material according to the present invention can also be produced under such ordinary conditions.

FIGS. 3A and 3B show rubbers chips 6 pulverized in a rubber mill, and pelletized rubber chips 7, respectively. As is apparent from these figures, there are clear and distinct differences between these two types of rubber chips.

### FIRST EXAMPLE

10% by weight of NBR (trade name: JSRN 230SH; made by JSR Corporation) was added to 90% by weight of grinding dust obtained by grinding friction materials whose compositions are identical to each other, and the mixture was kneaded together and formed into a sheet in an open-roll mill. The thus obtained rubber sheet (in which the grinding dust is bound by rubber) was cut to a predetermined size, and pulverized in a rubber mill (Model OMS-1000; made by Sigma Seiki Co., Ltd.) into randomly shaped rubber chips. The rubber chips had dimensions that are substantially equal to particle diameters of cashew dust, which is used in existing brake pads. FIG. 2 shows the particle diameter distribution of the rubber chips which was obtained by classifying the rubber chips in an air classifier. The content of the rubber chips having dimensions not less than 16 mesh (about 1 mm) was less than 1%. FIG. 2 shows that the particle diameter distribution of the thus obtained rubber chips is approximate to that of cashew dust.

15% by volume of the rubber chips were then added to 100% by volume of the basic material comprising the substances shown in Table 1 which were added at the rates shown in Table 1. The mixture was then formed into brake pads in a conventional manner. The brake pad obtained was evaluated for their performance.

The performance evaluation was conducted by measuring the shear strength, average friction coefficient (average p), friction coefficient during fading (fade p) and amount of wear of the lining (friction material) of the pad, as well as noise from the pad, and comparing the measurement results with those of an original pad not containing the rubber chips.

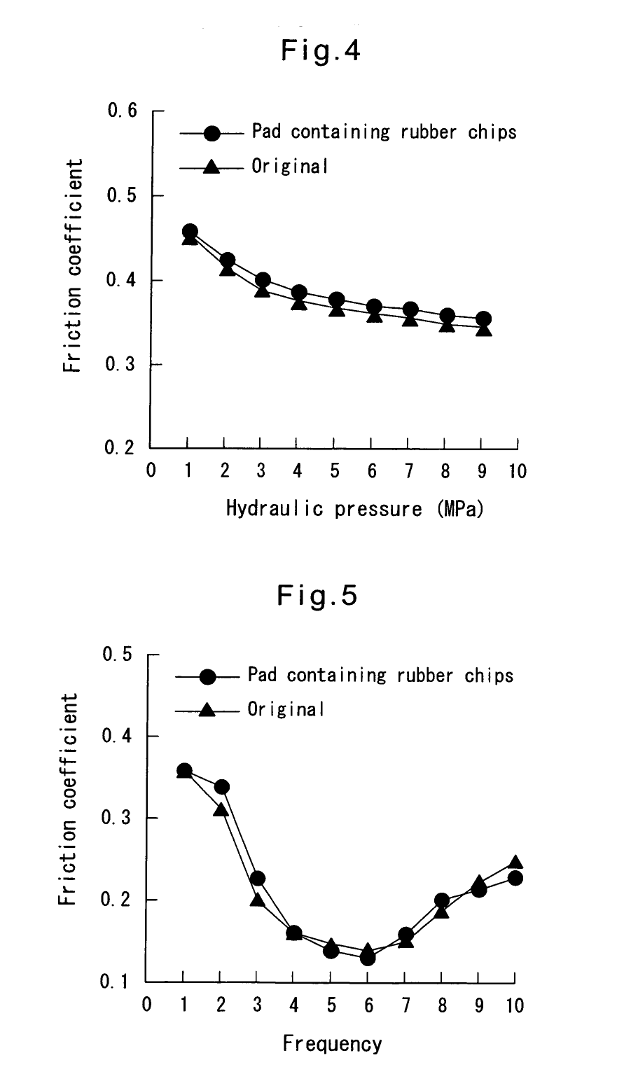

The results of the performance evaluation test are shown in Table 2 and FIGS. 4 and 5. The shear strength values shown in Table 2 were measured under JIS D4415.

The friction coefficient and the amount of wear of the friction material were measured with a full-size dynamo-tester under JASO (Japanese Automobile Standards Organization) C406-87, using a tire having an effective radius of 293 mm and a rotor having an effective radius of 100 mm, with an inertia of 6 kgm/s².

The brake used was the model PE57-14″25V, which is a floating one-pod disc brake for use in a 2000-cc class passenger car weighing about 1.3 tons having a piston diameter of 57 mm and including a ventilated rotor having a diameter of 14 inches.

The average friction coefficient (average p) was measured by the second effect under JASO C406-87 at 50 km/h before braking. The lowest p of the fade pattern was indicated as the fade μ. The average μ should be 0.4±0.05, and the fade μ should be not less than 0.10. The amount of wear was calculated from the thicknesses of the pad before and after the test. The existence of noise was audibly determined by a driver when, with the pads mounted on an actual vehicle, the brake is applied a predetermined times with different rotor temperatures and different pedal forces.

TABLE 1

| | Content (vol %) |
|---|---|
| Phenolic resin | 18 |
| Aramid fiber | 10 |
| Cashew dust | 15 |
| Steel fiber | 2 |
| Copper fiber | 5 |
| Rockwool | 10 |
| Graphite | 10 |
| Calcium hydroxide | 4 |
| Inorganic filler | 26 |
| Total | 100 |

TABLE 2

| | | | Pad containing |
|---|---|---|---|
| | | Original pad | rubber chips |
| Shear strength of the lining | | 23 kN | 22 kN |
| Friction coefficient | Average μ | 0.38 | 0.39 |
| | Fade μ | 0.13 | 0.13 |

| | | |
|---|---|---|
| Amount of wear | 0.5 | 0.6 |
| Noise | No | No |

The test results clearly show that a friction material such as a brake pad which contains rubber chips in which cutting/machining dust of friction material is kneaded shows high performance comparable to a conventional friction material containing no rubber chips, provided such rubber chips are fine chips pulverized by a rubber mill to random shapes.

With this arrangement, it is possible to use machining/cutting dust produced daily when friction materials are machined or cut, thereby reducing industrial waste as well as the cost of the friction material. Since machining/cutting dust is bound by rubber, the dust is never scattered during handling. This prevents environmental pollution.

Because the rubber chips can be handled in the same manner as cashew dust contained in friction materials, the friction material can be produced in the same manner as conventional friction materials. Use of such rubber chips therefore does not result in reduced productivity.

### SECOND EXAMPLE

To 100% by volume of the basic material used in First Example and shown in Table 1 were added 15% by volume of randomly shaped rubber chips produced in the same manner as in First Example (the grinding dust is produced from friction materials having identical compositions to each other, and the rubber is NBR as in First Example, the particle diameters being substantially equal to those of cashew dust used in existing brake pads). Different brake pads were produced using a conventional method so that the ratio of the rubber to the grinding dust in the rubber chips and the total content of rubber in the pads are different from each other as shown in Table 3. The respective specimens (brake pads) were evaluated for their performance. Also, for the respective specimens, the recycling rate of the grinding dust of friction material was determined.

The evaluated items, the manner of evaluation, and the evaluation conditions were the same as those of First Example. The results of the evaluation tests and the results of determination on the grinding dust recycling rate are shown in Table 3. In Table 3, the symbols ◯, Δ and X in the item of “Grinding dust recycling rate” indicate the grinding dust recycling rates of not less than 10% by weight, between 5 and 10% by weight, and less than 5% by weight, respectively.

TABLE 3

| | | Comp. | | | | | | | | | |
|---|---|---|---|---|---|---|---|---|---|---|---|
| | | Example 1 | Example 1 | Example 2 | Example 3 | Example 4 | Example 5 | Example 6 | Example 7 | Example 8 | Example 9 |
| Rubber/grinding dust ratio | | — | 5/95 | 5/95 | 5/95 | 5/95 | 5/95 | 10/90 | 10/90 | 10/90 | 10/90 |
| (weight) | | | | | | | | | | | |
| Total rubber content in the | | — | 0.2 | 0.5 | 1 | 2 | 3 | 0.5 | 1 | 2.5 | 3 |
| pad | | | | | | | | | | | |
| Grinding dust recycling rate | | — | X | ◯ | ◯ | ◯ | ◯ | X | ◯ | ◯ | ◯ |
| Lining shear strength (kN) | | 19 | 20 | 19 | 16 | 16 | 15 | 19 | 18 | 19 | 16 |
| Friction | Average μ | 0.38 | 0.39 | 0.40 | 0.42 | 0.42 | 0.44 | 0.38 | 0.38 | 0.38 | 0.39 |
| coefficient | Fade μ | 0.20 | 0.19 | 0.19 | 0.20 | 0.18 | 0.13 | 0.13 | 0.18 | 0.16 | 0.13 |
| Wear amount (mm) | | 0.5 | 0.5 | 0.6 | 0.5 | 0.4 | 0.3 | 0.2 | 0.7 | 0.5 | 0.3 |
| Noise | | No | No | No | No | No | No | No | No | No | No |
| | | Example | Example | Example | Example | Example | Example | Example | Example | Example | Example |
| | | 10 | 11 | 12 | 13 | 14 | 15 | 16 | 17 | 18 | 19 |
| Rubber/grinding dust ratio | | 10/90 | 15/85 | 15/85 | 15/85 | 15/85 | 15/85 | 15/85 | 15/85 | 25/75 | 25/75 |
| (weight) | | | | | | | | | | | |
| Total rubber content in the | | 3.5 | 0.2 | 0.5 | 1 | 2 | 2.5 | 3 | 4 | 0.5 | 1 |
| pad | | | | | | | | | | | |
| Grinding dust recycling rate | | ◯ | X | X | Δ | ◯ | ◯ | ◯ | ◯ | X | Δ |
| Lining shear strength (kN) | | 11 | 20 | 19 | 19 | 18 | 18 | 16 | 10 | 17 | 18 |
| Friction | Average μ | 0.39 | 0.41 | 0.42 | 0.38 | 0.40 | 0.39 | 0.40 | 0.39 | 0.37 | 0.41 |
| coefficient | Fade μ | 0.11 | 0.21 | 0.21 | 0.18 | 0.15 | 0.14 | 0.12 | 0.11 | 0.22 | 0.19 |

| | | | | | | | | | | |
|---|---|---|---|---|---|---|---|---|---|---|
| Wear amount (mm) | 0.3 | 0.6 | 0.7 | 0.6 | 0.5 | 0.5 | 0.4 | 0.2 | 0.6 | 0.7 |
| Noise | No | No | No | No | No | No | No | No | No | No |

| | | Example | Example | Example | Example | Example | Example |
|---|---|---|---|---|---|---|---|
| | | 20 | 21 | 22 | 23 | 24 | 25 |
| Rubber/grinding dust ratio | | 25/75 | 25/75 | 25/75 | 30/70 | 50/50 | 55/45 |
| (weight) | | | | | | | |
| Total rubber content in the pad | | 2.5 | 3 | 4 | 2.5 | 2.5 | 2.5 |
| Grinding dust recycling rate | | Δ | Δ | ◯ | Δ | Δ | X |
| Lining shear strength (kN) | | 18 | 15 | 11 | 16 | 16 | 17 |
| Friction | Average μ | 0.41 | 0.4 | 0.39 | 0.40 | 0.39 | 0.38 |
| coefficient | Fade μ | 0.17 | 0.16 | 0.13 | 0.15 | 0.15 | 0.12 |

| | | | | | | |
|---|---|---|---|---|---|---|
| Wear amount (mm) | 0.5 | 0.5 | 0.4 | 0.5 | 0.6 | 0.6 |
| Noise | No | No | No | No | No | No |

From the results of Second Example, the friction materials (pads) according to the present invention, which contain randomly shaped rubber chips containing grinding dust of friction material, are comparable in frictional characteristics to Comparable Example, which contains no rubber chips. As described above, the average μ should be 0.4±0.05, and the fade μ should be not less than 0.10. All the Examples meet these requirements.

For the shear strength of the lining, it was discovered that the total rubber content in the friction material (lining) has to be within a suitable range. Specifically, if the total rubber content exceeds 3% by weight, the shear strength of the lining markedly decreases (Examples 10, 17 and 22). For pads used for brakes of the above-described PE57-14″25V type, the guaranteed value of the lining shear strength is not less than 12 kN. Thus, the pads of Examples 10, 17 and 22 may not be usable for brakes of particular types due to the fact that the lining shear strength is less than the guaranteed value.

On the other hand, if the total rubber content is less than 0.5% by weight, although the performance of the friction material scarcely changes, the recycling rate of grinding dust and other machining/cutting dust decreases (Examples 1, 6, 11, 12 and 18). Thus, the total rubber content is preferably not less than 0.5% by weight. If the rubber-to-dust rate in the rubber chips exceeds 50%, the recycling rate also decreases (Example 25). Thus, the rubber-to-dust rate is preferably not more than 50%.

As for the handleability of the grinding dust-containing randomly shaped rubber chips according to the present invention, they were as easily handleable as cashew dust.

The friction material according to this invention is not limited to use for brakes but may be used e.g. for clutch facings.

What is claimed is:

1. A friction material comprising a fibrous base material, a friction adjuster, a binder, an inorganic filler, and randomly shaped rubber chips made from kneading rubber and machining dust of friction material.

2. The friction material of claim 1 wherein the rubber chips are sized so as to pass through a 16-mesh sieve.

3. The friction material of claim 1 wherein the total rubber content in said rubber chips is 3% by weight of the entire friction material.

4. The friction material of claim 1 wherein the weight ratio of the rubber in said rubber chips to the machining dust in said rubber chips is 50/50 to 5/95.
